(19) United States
(12) Patent Application Publication
(10) Pub. No.: US 2020/0062891 A1
(43) Pub. Date: Feb. 27, 2020

(54) GOOD WEATHERING, UV-RESISTANT UNSATURATED POLYESTER RESIN COMPRISING FUMARIC ACID

(71) Applicant: ASHLAND LICENSING AND INTELLECTUAL PROPERTY LLC, Dublin, OH (US)

(72) Inventors: Husam A. A. RASOUL, Plain City, OH (US); Pirjo Leena NISSILÄ, Espoo (FI); Taru Anniina NIKKONEN, Vantaa (FI); Tuomo Tapio SJÖBERG, Helsinki (FI); Petri SIPOLA, Hamina (FI)

(73) Assignee: ASHLAND LICENSING AND INTELLECTUAL PROPERTY LLC, Dublin, OH (US)

(21) Appl. No.: 16/346,236

(22) PCT Filed: Oct. 31, 2017
(86) PCT No.: PCT/US17/59232

§ 371 Date: Apr. 30, 2019

Related U.S. Application Data
(60) Provisional application No. 62/415,581, filed on Nov. 1, 2016.

(51) Int. Cl. C08G 63/16; C08G 63/91; C08K 3/36; C08K 5/14

(52) U.S. Cl. CPC C08G 63/16; C08G 63/916; C08K 2201/005; C08K 5/14; C08K 3/36

(57) ABSTRACT

The invention relates to an unsaturated polyester resin comprising fumaric acid and optional end-capping with an ethylenically unsaturated moiety, which is useful for the preparation of engineered stone. The unsaturated polyester resin can be further processed to obtain a formable composition which can be cured to finally yield engineered stone as composite material. The thus obtained engineered stone shows a high resistance to UV- and sunlight as well as to weathering. The invention also relates to a method for the preparation of engineered stone as well as to the use of the unsaturated polyester resin for the preparation of engineered stone.

The invention relates to an unsaturated polyester resin comprising fumaric acid and optional end-capping with an ethylenically unsaturated moiety, which is useful for the preparation of engineered stone. The unsaturated polyester resin can be further processed to obtain a formable composition which can be cured to finally yield engineered stone as composite material. The thus obtained engineered stone shows a high resistance to UV- and sunlight as well as to weathering. The invention also relates to a method for the preparation of engineered stone as well as to the use of the unsaturated polyester resin for the preparation of engineered stone.

Engineered stone and the process for making it are very well known for a number of years. Polyester resins are the most commonly used binding resins, which are combined and mixed with aggregates of different particle size, pigments and additives. The homogenous mixture may be subjected e.g. to vibro-compression (=vibro compaction) under vacuum in a mold followed by curing the resin at elevated temperatures resulting in slabs that can be polished and cut to the desired dimensions. The curable resins used in this process are general linear polyesters obtained by reacting aromatic acids or anhydrides with diols and an unsaturated component such as maleic acid anhydride dissolved in styrene. Resins with this type of composition generally exhibit poor weathering and low resistance to UV-light and cannot be used for outdoor applications.

US 2010/0063193 and US 2011/0207849 relate to a process for manufacturing outdoor artificial stone boards with methacrylate resin by means of the vibro-compression under vacuum system.

U.S. Pat. No. 7,727,435 relates to an engineered stone composite produced from a mineral aggregate, a synthetic resin and a binder using compression and vibrations to obtain a high strength mineral composite with a high mineral content and a method for its preparation.

Conventional resin formulations are not suitable for outdoor applications and there is a demand for methods for the preparation of engineered stone that have advantages compared to the prior art. The engineered stone for outdoor applications should be easy to manufacture by means of conventional equipment and should exhibit excellent UV-resistance and weathering properties.

This object has been achieved by the subject-matter of the patent claims.

It has been surprisingly found that engineered stone having excellent weathering properties can be prepared from unsaturated polyester resin comprising fumaric acid as the major or even as the only source of unsaturation in the polyester backbone. The properties of the unsaturated polyester resin can be further improved by full or partial end-capping with aliphatic unsaturated moieties. The engineered stone manufactured from the unsaturated polyester resin exhibits excellent UV-resistance and weathering properties and additionally maintains desired mechanical properties.

A first aspect of the invention relates to an unsaturated polyester resin component for the preparation of engineered stone, wherein the unsaturated polyester resin component has a weight average molecular weight within the range of from about 1000 g/mol to about 7500 g/mol; and wherein the unsaturated polyester resin component is obtainable by

(a) reacting a monomer mixture comprising, preferably essentially consisting of
(i) a fumaric acid component comprising fumaric acid and/or a fumaric acid ester;
(ii) a polyfunctional alcohol component comprising at least one polyfunctional alcohol selected from the group consisting of
   aromatic polyfunctional alcohols; and
   aliphatic polyfunctional alcohols;
(iii) optionally, a polycarboxylic acid component comprising at least one polycarboxylic acid selected from the group consisting of
   aromatic polycarboxylic acids, anhydrides or esters thereof;
   saturated aliphatic polycarboxylic acids, anhydrides or esters thereof; and
   unsaturated aliphatic polycarboxylic acids, anhydrides or esters thereof differing from fumaric acid and fumaric acid ester;
(iv) optionally, a monocarboxylic acid component comprising at least one monocarboxylic acid selected from the group consisting of
   aromatic monocarboxylic acids, anhydrides or esters thereof; and
   aliphatic monocarboxylic acids, anhydrides or esters thereof; and
(v) optionally, a monofunctional alcohol component comprising at least one monofunctional alcohol selected from the group consisting of
   aromatic monofunctional alcohols, and
   aliphatic monofunctional alcohols;
wherein
   the molar content of the (i) fumaric acid component is within the range of from about 5.0 to about 50 mol.-%; and
   the molar content of the (ii) polyfunctional alcohol component is within the range of from about 20 to about 90 mol.-%;
   wherein said molar content in each case is relative to the total molar content of the (i) fumaric acid component, the (ii) polyfunctional alcohol component, the (iii) optionally present polycarboxylic acid component, the (iv) optionally present monocarboxylic acid component, and the (v) optionally present monofunctional alcohol component in the monomer mixture; and
      (b) optionally, end-capping the product of step (a).

For the purpose of the invention, “poly” means “at least two”. Thus, a polycarboxylic acid has at least two carboxylic groups (diacid, triacid, etc.), whereas a polyfunctional alcohol has at least two hydroxyl groups (diol, triol, etc.).

For the purpose of the invention, “component” refers to a constituent that may be composed of a single compound or of a plurality (e.g. mixture) of compounds having a common property. For example, a polycarboxylic acid component may consist of a single polycarboxylic acid or of a mixture of 2, 3 or 4 different polycarboxylic acids.

For the purpose of the invention, “ester” of a carboxylic acid preferably refers to an ester with an aliphatic alcohol selected from the group consisting of methanol, ethanol, n-propanol, iso-propanol, n-butanol, iso-butanol, sec-butanol and tert-butanol.

The unsaturated polyester resin component according to the invention has a weight average molecular weight within the range of from about 1000 g/mol to about 7500 g/mol, preferably within the range of from about 1500 g/mol to about 7200 g/mol; more preferably in the range from about 2000 g/mol to about 6900 g/mol. In another preferred embodiment the unsaturated polyester resin component has a weight average molecular weight within the range of about 2650±1200 g/mol; about 2650±1100 g/mol; about 2650±1000 g/mol; or about 2650±900 g/mol; or about 2650±800 g/mol; or about 2650±700 g/mol; or about 2650±600 g/mol.

Suitable methods for measuring the weight average molecular weight of unsaturated polyester resins are known to the skilled person and include size exclusion chromatography.

Suitable methods for altering the weight average molecular weight of unsaturated polyester resins are known to the skilled person. The average molecular weight can be influenced by the content of polyfunctional monomers and the mole ration of acid to hydroxyl groups in the reaction mixture as well as by the content of monofunctional monomers thereby influencing the degree of end-capping.

Preferably, the reaction product obtained from reacting the monomer mixture has an acid value within the range of from about 2 to about 50 and/or a hydroxyl-value within the range of from about 60 to about 150. More preferably the acid value is in the range of about 10±8, even more preferred in the range of about 10±7, most preferred in the range of 10±6. In another preferred embodiment the acid value can be in the range of about 30 to about 50, more preferred in the range of 42±4. The hydroxyl-value is more preferably within the range of about 105±40, or about 105±20, or about 105±15, or about 105±5.

Suitable methods to determine the acid value of unsaturated polyester resin are known to the skilled person and include titration with a base. Suitable methods to determine the hydroxyl value of unsaturated polyester resin are known to the skilled person and include acetylation of the hydroxyl groups with acetic anhydride, conversion of the unreacted acetic anhydride to acetic acid and subsequent titration with a base.

The unsaturated polyester resin component is obtained or is obtainable by the reaction of fumaric acid and/or fumaric acid ester with polyfunctional alcohol monomers. The product may then optionally be end-capped with moieties comprising ethylenic unsaturations. The polyester—with or without endcapping—may be dissolved in an ethylenically unsaturated reactive monomer, such as styrene, to obtain a solution that may then be crosslinked. One skilled in the art will appreciate that there are many different processes and methods for making unsaturated polyester resin components and other resins having ethylenic unsaturation that may be applied within the scope of the invention.

The unsaturated polyester resin component according to the invention is obtained or is obtainable from a monomer mixture comprising a fumaric acid component comprising fumaric acid, and/or fumaric acid ester. Preferably, the fumaric acid component comprises fumaric acid.

The unsaturated polyester resin component is obtained or obtainable by reacting a monomer mixture comprising a fumaric acid component, wherein the molar content of the fumaric acid component is within the range of from about 5.0 to about 50 mol.-%, wherein said molar content is relative to the total molar content of the fumaric acid component, the polyfunctional alcohol component, the optionally present polycarboxylic acid component, the optionally present monocarboxylic acid component, and the optionally present monofunctional alcohol component in the monomer mixture.

Preferably, the molar content of the fumaric acid component is within the range of about 40±10 mole.-%, or about 40±5 mole.-%, or about 30±20 mole.-%, or about 30±15 mole.-%, or about 30±10 mole.-%, or about 30±5 mole.-%, more preferably within the range of about or about 20±15 mole.-%, or about 20±14 mole.-%, or about 20±13 mole.-%, or about 20±12 mole.-%, or about 20±11 mole.-%, or about 20±10 mole.-%, or about 20±8 mole.-%, or about 20±6 mole.-%, or about 20±4 mole.-%, or about 20±2 mole.-%, or about 15±10 mole.-%, or about 15±8 mole.-%, or about 15±6 mole.-%, or about 15±4 mole.-%, or about 15±2 mole.-%, about 10±5 mole.-%, or about 10±4 mole.-%, or about 10±3 mole.-%, or about 10±2 mole.-%, wherein said molar content is relative to the total molar content of the fumaric acid component, the polyfunctional alcohol component, the optionally present polycarboxylic acid component, the optionally present monocarboxylic acid component, and the optionally present monofunctional alcohol component in the monomer mixture.

In a preferred embodiment, the molar content of the fumaric acid component is in the range of 23±10 mole.-%, wherein said molar content is relative to the total molar content of the fumaric acid component, the polyfunctional alcohol component, the optionally present polycarboxylic acid component, the optionally present monocarboxylic acid component, and the optionally present monofunctional alcohol component in the monomer mixture. In another preferred embodiment, the molar content of the fumaric acid component is in the range of 30±3 mole.-% wherein said molar content is relative to the total molar content of the fumaric acid component, the polyfunctional alcohol component, the optionally present polycarboxylic acid component, the optionally present monocarboxylic acid component, and the optionally present monofunctional alcohol component in the monomer mixture.

Preferably, the molar content of the fumaric acid component is in the range of from about 5 to about 95 mole.-%, wherein said molar content is relative to the total molar content of the fumaric acid component, the optionally present polycarboxylic acid component and the optionally present monocarboxylic acid component in the monomer mixture (i.e. relative to all carboxylic acid components).

In preferred embodiments, the molar content of the fumaric acid component is in the range of about 80±15 mole.-%, or about 80±10 mole.-%, or about 80±5 mole.-%, or about 70±25 mole.-%, or about 70±20 mole.-%, or about 70±15 mole.-%, or about 70±10 mole.-%, or about 60±35 mole.-%, or about 60±30 mole.-%, or about 60±20 mole.-%, or about 60±15 mole.-%, or about 60±10 mole.-%, or about 50±45 mole.-%, or about 50±40 mole.-%, or about 50±30 mole.-%, or about 50±20 mole.-%, or about 50±15 mole.-%, or about 50±10 mole.-%, or about 40±35 mole.-%, or about 40±30 mole.-%, or about 40±20 mole.-%, or about 40±15 mole.-%, or about 40±10 mole.-%, or about 30±25 mole.-%, or about 30±20 mole.-%, or about 30±15 mole.-%, or about 30±10 mole.-%, or about 20±15 mole.-%, or about 20±10 mole.-%, or about 20±5 mole.-%, wherein said molar content is relative to the total molar content of the fumaric acid component, the optionally present polycarboxylic acid component and the optionally present monocarboxylic acid component in the monomer mixture (i.e. relative to all carboxylic acid components).

Preferably, the fumaric acid component is the only component in the monomer mixture which comprises an ethylenic unsaturation. A person skilled in the art recognizes that the product obtained from reacting such a monomer mixture is an unsaturated polyester wherein the fumaric acid component is the major or the only source of unsaturation in the polyester backbone. Further, a skilled person recognizes that due to harsh reaction conditions the polyester backbone may also contain minor amounts of maleic acid, i.e. the isomer of fumaric acid. Furthermore, during the polymerization of the monomers water is formed which may hydrolyze fumaric acid to malic acid. Experimental data of a product obtained from reacting a monomer mixture according to the invention show that maleic acid can be present in the unsaturated polyester resin in amount of up to about 2.2 wt.-% and malic acid can be present in the unsaturated polyester resin in amount of up to about 9.1 wt.-%.

Preferably, the molar content of the fumaric acid component is at least 90 mole.-%, more preferably at least 95 mole.-%, still more preferably at least 99 mole.-%, and in particular essentially 100 mole.-%, relative to the total content of ethylenically unsaturated monomers in the monomer mixture, i.e. not including any ethylenic unsaturations that might optionally be contained in the end-capping moieties.

Preferably,
the fumaric acid component is the only component in the monomer mixture which comprises an ethylenic unsaturation; and/or
the unsaturated polyester resin component is aliphatic or aromatic.

In a preferred embodiment of an aromatic unsaturated polyester resin component, an alcohol component of the monomer mixture is aromatic and/or a carboxylic acid component of the monomer mixture is aromatic.

In a preferred embodiment
the fumaric acid component is the only component in the monomer mixture which comprises an ethylenic unsaturation; and/or
the unsaturated polyester resin component is aliphatic, i.e. the unsaturated polyester resin component is preferably obtainable by
   (a) reacting a monomer mixture comprising, preferably consisting of
(i) a fumaric acid component comprising fumaric acid and/or a fumaric acid ester;
(ii) a polyfunctional alcohol component comprising at least one polyfunctional alcohol selected from the group consisting of aliphatic polyfunctional alcohols;
(iii) optionally, a polycarboxylic acid component comprising at least one polycarboxylic acid selected from the group consisting of
   saturated aliphatic polycarboxylic acids, anhydrides or esters thereof; and
   unsaturated aliphatic polycarboxylic acids, anhydrides or esters thereof differing from fumaric acid and fumaric acid ester;
(iv) optionally, a monocarboxylic acid component comprising at least one monocarboxylic acid selected from the group consisting of aliphatic monocarboxylic acids, anhydrides or esters thereof; and
(v) optionally, a monofunctional alcohol component comprising at least one monofunctional alcohol selected from the group consisting of aliphatic monofunctional alcohols.

More preferably, the unsaturated polyester resin component, is preferably obtainable by

(a) reacting a monomer mixture comprising, preferably consisting of
(i) a fumaric acid component comprising fumaric acid and/or a fumaric acid ester;
(ii) a polyfunctional alcohol component comprising at least one polyfunctional alcohol selected from the group consisting of aliphatic polyfunctional alcohols;
(iii) optionally, a polycarboxylic acid component comprising at least one polycarboxylic acid selected from the group consisting of saturated aliphatic polycarboxylic acids, anhydrides or esters thereof; and
(iv) optionally, a monocarboxylic acid component comprising at least one monocarboxylic acid selected from the group consisting of saturated aliphatic monocarboxylic acids, anhydrides or esters thereof; and
(v) optionally, a monofunctional alcohol component comprising at least one monofunctional alcohol selected from the group consisting of saturated aliphatic monofunctional alcohols.

In another preferred embodiment
the fumaric acid component is the only component in the monomer mixture which comprises an ethylenic unsaturation; and/or
the unsaturated polyester resin component is aromatic, i.e. the unsaturated polyester resin component is preferably obtainable by
   (a) reacting a monomer mixture comprising, preferably consisting of
(i) a fumaric acid component comprising fumaric acid and/or a fumaric acid ester;
(ii) a polyfunctional alcohol component comprising at least one polyfunctional alcohol selected from the group consisting of aromatic polyfunctional alcohols;
(iii) optionally, a polycarboxylic acid component comprising at least one polycarboxylic acid selected from the group consisting of aromatic polycarboxylic acids, anhydrides or esters thereof;
(iv) optionally, a monocarboxylic acid component comprising at least one monocarboxylic acid selected from the group consisting of aromatic monocarboxylic acids, anhydrides or esters thereof; and
(v) optionally, a monofunctional alcohol component comprising at least one monofunctional alcohol selected from the group consisting of aromatic monofunctional alcohols.

The unsaturated polyester resin component according to the invention is obtained or is obtainable from a monomer mixture comprising a polyfunctional alcohol component comprising at least one polyfunctional alcohol selected from the group consisting of aromatic polyfunctional alcohols and aliphatic polyfunctional alcohols.

Preferably, the polyfunctional alcohol is a saturated aliphatic polyfunctional alcohol selected from the group consisting of saturated aliphatic diols, saturated aliphatic triols, saturated aliphatic tetraols.

Examples of saturated aliphatic polyfunctional alcohols include but are not limited to ethylene glycol, propylene glycol, 1,3-propanediol, 1,4-butanediol, 2-methyl-1,3-propanediol, glycerol, neopentyl glycol, trimethylol propane and oxyalkylated adducts thereof such as glycol ethers, e.g. diethylene glycol, dipropylene glycol, and polyoxyalkylene glycol.

Preferably, the polyfunctional alcohol is an unsaturated aliphatic polyfunctional alcohol selected from the group consisting of unsaturated aliphatic diols, unsaturated aliphatic triols, unsaturated aliphatic tetraols.

Preferably, the polyfunctional alcohol is an aromatic polyfunctional alcohol selected from the group consisting of aromatic diols, aromatic triols and aromatic tetraols. More preferred, the aromatic polyfunctional alcohol is benzenedimethanol.

In a preferred embodiment, the polyfunctional alcohol is selected from aliphatic and aromatic polyfunctional alcohols, wherein the term “aliphatic” covers acyclic and cyclic, saturated and unsaturated polyfunctional alcohols. Preferably, the polyfunctional alcohol is selected from aliphatic polyfunctional alcohols. More preferably, the polyfunctional alcohols are selected from aliphatic polyfunctional alcohols having from about 2 to about 12 carbon atoms. Still more preferably, the polyfunctional alcohols are selected from diols having from about 2 to about 10 carbon atoms, most preferably from diols having about 2, 3, 4, 6, 7, 8, 9 or 10 carbon atoms. It is particularly preferred that the polyfunctional alcohol is a diol having 2 carbon atoms.

Exemplary diols include alkanediols, butane-1,4-diol, 2-butyl-2-ethyl-1,3-propanediol (BEPD), 1,3-butylene glycol, cyclohexane-1,2-diol, cyclohexane dimethanol, diethyleneglycol, 2,2-dimethyl-1,4-butanediol, 2,2-dimethylheptanediol, 2,2-dimethyloctanediol, dipropylene glycol, ethyleneglycol, hexane-1,6-diol, 2-methyl-1,3-propanediol, neopentyl glycol, 2,3-norbornene diol, oxa-alkanediols, 1,2-propanediol, triethyleneglycol, 2,2,4-trimethyl-1,3-pentanediol, and 2,2-bis(4-hydroxycyclohexyl)-propane.

In a preferred embodiment, the polyfunctional alcohol is a diol selected from the group consisting of butane-1,4-diol, 2-butyl-2-ethyl-1,3-propanediol (BEPD), 1,3-butylene glycol, cyclohexane-1,2-diol, cyclohexane dimethanol, diethylenglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, ethylene glycol, hexane-1,6-diol, 2-methyl-1,3-propanediol, neopentyl glycol, 5-norbornene-2,2-dimethylol, 2,3-norbornene diol, oxa-alkanediols, pentaerythritol, polyethylene glycol, propane-3-diol, 1,2-propanediol (also called 1,2-propyleneglycol), triethyleneglycol, trimethylolpropane, 2,2,4-trimethyl-1,3-pentanediol, and 2,2-bis(4-hydroxycyclohexyl)-propane. More preferably, the polyfunctional alcohol is selected from the group consisting of ethylene glycol, neopentyl glycol, propylene glycol and diethylene glycol.

Preferably, the polyfunctional alcohol component comprises a mixture of at least two saturated aliphatic polyfunctional alcohols; preferably selected from the group consisting of ethylene glycol, diethylene glycol, neopentyl glycol, propylene glycol and 1,4-butanediol.

The unsaturated polyester resin component is obtained or obtainable by reacting a monomer mixture comprising a polyfunctional alcohol component wherein the molar content of the polyfunctional alcohol component is within the range of from 20 to 90 mol.-%, wherein said molar content is relative to the total molar content of the fumaric acid component, the polyfunctional alcohol component, the optionally present polycarboxylic acid component, the optionally present monocarboxylic acid component, and the optionally present monofunctional alcohol component in the monomer mixture.

In a preferred embodiment the molar content of the polyfunctional alcohol component is within the range of about 55±15 mole.-%, or about 55±10 mole.-%, or about 55±5 mole.-%, or about 55±3 mole.-%, wherein said molar content is relative to the total molar content of the fumaric acid component, the polyfunctional alcohol component, the optionally present polycarboxylic acid component, the optionally present monocarboxylic acid component, and the optionally present monofunctional alcohol component in the monomer mixture.

Preferably, the molar content of the polyfunctional alcohol component is within the range of about 80±10 mole.-%, or about 80±5 mole.-%, or about 70±20 mole.-%, or about 70±15 mole.-%, or about 70±10 mole.-%, or about 60±30 mole.-%, or about 60±20 mole.-%, or about 60±15 mole.-%, or about 60±10 mole.-%, or about 50±30 mole.-%, or about 50±20 mole.-%, or about 50±15 mole.-%, or about 50±10 mole.-%, or about 40±20 mole.-%, or about 40±15 mole.-%, or about 40±10 mole.-%, or about 30±10 mole.-%, or about 30±5 mole.-%, wherein said molar content in each case is relative to the total molar content of the fumaric acid component, the polyfunctional alcohol component, the optionally present polycarboxylic acid component, the optionally present monocarboxylic acid component, and the optionally present monofunctional alcohol component in the monomer mixture.

In a preferred embodiment, the monomer mixture does not comprise an aromatic polyfunctional alcohol.

In another preferred embodiment, the monomer mixture comprises an aromatic polyfunctional alcohol, whereas the total content of said aromatic polyfunctional alcohol is preferably not more than 50 mole.-%, more preferably not more than 45 mole.-%, still more preferably not more than 40 mole.-%, yet more preferably not more than 35 mole.-%, even more preferably not more than 30 mole.-%, most preferably not more than 25 mole.-%, and in particular not more than 20 mole.-%, in each case relative to the total content of the polyfunctional alcohol component that is contained in the monomer mixture.

The unsaturated polyester resin component according to the invention is obtained or is obtainable from a monomer mixture which can optionally comprise a polycarboxylic acid component comprising at least one polycarboxylic acid selected from the group consisting of aromatic polycarboxylic acids, anhydrides or esters thereof; saturated aliphatic polycarboxylic acids, anhydrides or esters thereof; and unsaturated aliphatic polycarboxylic acids, anhydrides or esters thereof differing from fumaric acid and fumaric acid ester.

In a preferred embodiment, the polycarboxylic acid component comprises a carboxylic acid, a carboxylic acid ester and/or a carboxylic acid anhydride, wherein the carboxylic acid, the carboxylic acid ester and/or the carboxylic acid anhydride are/is selected from aliphatic and aromatic polycarboxylic acids and/or the esters and anhydrides thereof, wherein the term “aliphatic” covers acyclic and cyclic, saturated and unsaturated polycarboxylic acids and the esters and anhydrides thereof. Preferably, the carboxylic acid, the carboxylic acid ester and/or the carboxylic acid anhydride are/is selected from saturated polycarboxylic acids and/or the esters and anhydrides thereof.

Preferred aromatic polycarboxylic acids are selected from aromatic dicarboxylic acids, aromatic tricarboxylic acids, aromatic tetracarboxylic acids, and their corresponding acid anhydrides. A skilled person recognizes that the aromatic polycarboxylic acids may also be employed in form of esters, e.g. methyl esters or ethyl esters, in the corresponding transesterification reactions.

Exemplary aromatic polycarboxylic acids include isophthalic acid, phthalic acid, terephthalic acid, tetrachlorophthalic acid, trimellitic acid, 1,2,4,5-benzenetetracarboxylic acid, and 1,2,4-benzenetricarboxylic acid. Preferred aromatic polycarboxylic acids are isophthalic acid, phthalic acid, terephthalic acid, and tetrachlorophthalic acid. More preferred aromatic polycarboxylic acids are isophthalic acid, and phthalic acid. The most preferred aromatic polycarboxylic acid is isophthalic acid.

Exemplary aromatic polycarboxylic acid esters can be derived from isophthalic acid, phthalic acid, terephthalic acid, tetrachlorophthalic acid, trimellitic acid and 1,2,4,5-benzenetetra-carboxylic acid.

Exemplary aromatic polycarboxylic acid anhydrides can be derived from phthalic acid, tetrachlorophthalic acid, trimellitic acid and 1,2,4,5-benzenetetracarboxylic acid. Preferred aromatic polycarboxylic acid anhydrides are the aromatic polycarboxylic acid anhydrides of phthalic acid and tetrachlorophthalic acid. The most preferred aromatic polycarboxylic acid anhydride is phthalic anhydride.

In a preferred embodiment, the monomer mixture does not comprise an aromatic polycarboxylic acid, an aromatic polycarboxylic acid ester or an aromatic polycarboxylic acid anhydride.

In another preferred embodiment, the monomer mixture comprises an aromatic polycarboxylic acid, an aromatic polycarboxylic acid ester and/or an aromatic polycarboxylic acid anhydride, whereas the total content of said aromatic polycarboxylic acid, aromatic polycarboxylic acid ester or aromatic polycarboxylic acid anhydride is preferably not more than 50 mole.-%, more preferably not more than 45 mole.-%, still more preferably not more than 40 mole.-%, yet more preferably not more than 35 mole.-%, even more preferably not more than 30 mole.-%, most preferably not more than 25 mole.-%, and in particular not more than 20 mole.-%, in each case relative to the total content of the polycarboxylic acid component that is contained in the monomer mixture.

Preferred saturated aliphatic polycarboxylic acids are selected from the group consisting of saturated aliphatic dicarboxylic acids, saturated aliphatic tricarboxylic acids, saturated aliphatic tetracarboxylic acids, and their corresponding acid anhydrides. A skilled person recognizes that the saturated aliphatic polycarboxylic acids may also be employed in form of esters, e.g. methyl esters or ethyl esters, in the corresponding transesterification reactions.

Exemplary saturated aliphatic polycarboxylic acids include adipic acid, chlorendic acid, d-methyl glutaric acid, dodecanedicarboxylic acid, glutaric acid, hexahydrophthalic acid, malonic acid, suberic acid, azelaic acid, pimelic acid, sebacic acid, succinic acid, 1,2-cyclohexane dicarboxylic acid, 1,3-cyclohexane dicarboxylic acid and 1,4-cyclohexane dicarboxylic acid. Preferred saturated polycarboxylic acids are succinic acid, glutaric acid, d-methyl glutaric acid, adipic acid, sebacic acid, and pimelic acid. More preferred saturated polycarboxylic acids are adipic acid, succinic acid and glutaric acid. The most preferred saturated polycarboxylic acid is adipic acid.

Exemplary saturated polycarboxylic acid esters can be derived from adipic acid, chlorendic acid, di-methyl glutaric acid, dodecanedicarboxylic acid, glutaric acid, pimelic acid, sebacic acid, succinic acid, 1,2-cyclohexane dicarboxylic acid, 1,3-cyclohexane dicarboxylic acid and 1,4-cyclohexane dicarboxylic acid.

Exemplary saturated polycarboxylic acid anhydrides can be derived from adipic acid, chlorendic acid, dimethylglutaric acid, dodecanedicarboxylic acid, glutaric acid, pimelic acid, sebacic acid, succinic acid, 1,2-cyclohexane dicarboxylic acid, 1,3-cyclohexane dicarboxylic acid and 1,4-cyclohexane dicarboxylic acid. Preferred saturated polycarboxylic acid anhydrides are the saturated polycarboxylic acid anhydrides of chlorendic acid, dimethylglutaric acid, glutaric acid, hexahydrophthalic acid and succinic acid. More preferred saturated polycarboxylic acid anhydrides are hexahydrophthalic anhydride and succinic anhydride.

Preferred unsaturated aliphatic polycarboxylic acids, differing form fumaric acid, are selected from the group consisting of unsaturated aliphatic dicarboxylic acids, unsaturated aliphatic tricarboxylic acids, unsaturated aliphatic tetracarboxylic acids, and their corresponding acid anhydrides. A skilled person recognizes that the unsaturated aliphatic polycarboxylic acids may also be employed in form of esters, e.g. methyl esters or ethyl esters, in the corresponding transesterification reactions.

Exemplary unsaturated polycarboxylic acids differing form fumaric acid include chloromaleic acid, citraconic acid, itaconic acid, maleic acid, mesaconic acid, and methyleneglutaric acid. Preferred unsaturated polycarboxylic acids differing form fumaric acid are itaconic acid, maleic acid, mesaconic acid, glutaconic acid, traumatic acid, muconic acid, nadic acid, methylnadic acid and tetrahydrophthalic acid. More preferred unsaturated polycarboxylic acid differing form fumaric acid is maleic acid.

Exemplary unsaturated polycarboxylic acid esters differing form fumaric acid ester can be derived from chloromaleic acid, citraconic acid, itaconic acid, maleic acid, mesaconic acid, and methyleneglutaric acid. Preferred unsaturated polycarboxylic acids esters differing form fumaric acid ester are itaconic acid, maleic acid and mesaconic acid.

Exemplary unsaturated polycarboxylic acid anhydrides can be derived from chloromaleic acid, citraconic acid, itaconic acid, mesaconic acid, and methyleneglutaric acid. Preferred unsaturated polycarboxylic acid anhydrides are the unsaturated polycarboxylic acid anhydrides of chloromaleic acid, maleic acid, citraconic acid, and itaconic acid. More preferred unsaturated polycarboxylic acid anhydrides are maleic anhydride, citraconic anhydride, and itaconic anhydride. The most preferred unsaturated polycarboxylic acid anhydride is maleic anhydride.

Preferably, the molar content of the optionally present polycarboxylic acid component is within the range of range of about 20±10 mole.-%, or about 20±8 mole.-%, more preferably within the range of about 20±5 mole.-%, even more preferably within the range of about 20±3 mole.-%, wherein said molar content in each case is relative to the total molar content of the (i) fumaric acid component, the (ii) polyfunctional alcohol component, the (iii) optionally present polycarboxylic acid component, the (iv) optionally present monocarboxylic acid component, and the (v) optionally present monofunctional alcohol component in the monomer mixture.

Preferably, the unsaturated polyester resin component is obtained or is obtainable by reacting a monomer mixture wherein the polyfunctional alcohol component comprises a mixture of at least two saturated aliphatic polyfunctional alcohols and/or the optionally present polycarboxylic acid component comprises at least one saturated aliphatic polycarboxylic acid, anhydride or ester thereof.

In a preferred embodiment, the at least two saturated aliphatic polyfunctional alcohols are selected from the group consisting of ethylene glycol, diethylene glycol, propylene glycol and neopentyl glycol and/or the at least one saturated aliphatic polycarboxylic acid, anhydride or ester thereof is adipic acid or adipic acid anhydride.

Preferably, the molar ratio of the at least two saturated aliphatic polyfunctional alcohols is within the range of about 4:1 to about 1:4, more preferably within the range of about 3:1 to about 1:3, most preferably within the range of about 2:1 to about 1:2.

The unsaturated polyester resin component according to the invention may be obtained or is obtainable from a monomer mixture optionally comprising a monocarboxylic acid component.

The monocarboxylic acid component preferably comprises a monocarboxylic acid selected from aromatic carboxylic acids, saturated aliphatic monocarboxylic acids, unsaturated aliphatic carboxylic acids, esters and anhydrides thereof.

Exemplary monocarboxylic acids include benzoic acid and ethylhexanoic acid.

In a preferred embodiment, the monomer mixture does not comprise an aromatic monocarboxylic acid, an aromatic monocarboxylic acid ester or an aromatic monocarboxylic acid anhydride.

In another preferred embodiment, the monomer mixture comprises an aromatic monocarboxylic acid, an aromatic monocarboxylic acid ester and/or an aromatic monocarboxylic acid anhydride, whereas the total content of said aromatic monocarboxylic acid, aromatic monocarboxylic acid ester or aromatic monocarboxylic acid anhydride is preferably not more than 50 mole.-%, more preferably not more than 45 mole.-%, still more preferably not more than 40 mole.-%, yet more preferably not more than 35 mole.-%, even more preferably not more than 30 mole.-%, most preferably not more than 25 mole.-%, and in particular not more than 20 mole.-%, in each case relative to the total content of the monocarboxylic acid component that is contained in the monomer mixture.

In a preferred embodiment, the unsaturated polyester resin component according to the invention may be obtained or is obtainable from a monomer mixture not comprising a monocarboxylic acid component.

The unsaturated polyester resin component according to the invention may be obtained or is obtainable from a monomer mixture optionally comprising a monofunctional alcohol component.

The unsaturated polyester resin component preferably comprises at least one monofunctional alcohol selected from aromatic monofunctional alcohols, saturated aliphatic monofunctional alcohols, and unsaturated aliphatic monofunctional alcohols.

Exemplary monofunctional alcohols include benzyl alcohol, cyclohexanol, 2-ethyhexyl alcohol, 2-cyclohexyl ethanol, and lauryl alcohol.

In a preferred embodiment, the monomer mixture does not comprise an aromatic monofunctional alcohol.

In another preferred embodiment, the monomer mixture comprises an aromatic monofunctional alcohol, whereas the total content of said aromatic monofunctional alcohol is preferably not more than 50 mole.-%, more preferably not more than 45 mole.-%, still more preferably not more than 40 mole.-%, yet more preferably not more than 35 mole.-%, even more preferably not more than 30 mole.-%, most preferably not more than 25 mole.-%, and in particular not more than 20 mole.-%, in each case relative to the total content of the monofunctional alcohol component that is contained in the monomer mixture.

In a preferred embodiment, the unsaturated polyester resin component according to the invention may be obtained or is obtainable from a monomer mixture not comprising a monofunctional alcohol component.

Preferably, the unsaturated polyester resin component has a plastic viscosity at 125° C. in the range of 1.5 P to 5 P.

In a preferred embodiment, the product obtained by reacting the monomer mixture in step (a) can optionally be modified by end-capping.

Preferably, the product obtained by reacting the monomer mixture in step (a) is end-capped with moieties comprising ethylenic unsaturations. Typically, the moieties comprising ethylenic unsaturations differ from the components comprised in the monomer mixture.

Preferably, the unsaturated polyester resin component is end-capped by reacting the terminal hydroxyl groups and/or the terminal carboxyl groups of the product obtained by reacting the monomer mixture with a functionalizer.

In a preferred embodiment, the molar ratio of end-capped said terminal hydroxyl groups and/or the said terminal carboxyl groups to not end-capped said terminal hydroxyl groups and/or the said terminal carboxyl groups is in the range from about 9:1 to about 1:9, more preferred in the range from about 6:1 to about 1:6, and most preferred in the range from about 3:1 to about 1:3.

Preferably, the reaction of the said terminal hydroxyl groups or the said terminal carboxyl groups with a functionalizer can be either a one-step reaction with a functionalizer or a two-step reaction with a functionalizer and subsequently with an end-capping agent.

In a preferred embodiment, the functionalizer
bears a functional group capable of reacting with said terminal hydroxyl groups or said terminal carboxyl groups; and
bears the ethylenic unsaturation.

Preferably, the functionalizer bears the ethylenic unsaturation and is selected from the group consisting of

glycidyl(meth)acrylate; or

allyl isocyanate and adducts of 2-hydroxyethylmethacrylate and isocyanate.

In another preferred embodiment, the functionalizer
bears a functional group capable of reacting with said terminal hydroxyl groups or said terminal carboxyl groups; and
does not bear the ethylenic unsaturation, but bears a functional group capable of subsequently reacting with an end-capping agent bearing the ethylenic unsaturation.

Preferably,
the functionalizer does not bear the ethylenic unsaturation and is selected from the group consisting of alicyclic polyisocyanates, aromatic polyisocyanates and aliphatic polyisocyanates; and
the end-capping agent is selected from the group consisting of unsaturated alcohols and hydroxyl substituted acrylic and methacrylic acid esters.

More preferably,
the functionalizer does not bear the ethylenic unsaturation and is selected from the group consisting of isopherone diisocyanate, dimethyl dicyclohexane diisocyanate, toluene dissocyanate, methylene diphenyl diisocyanate and hexanediisocyanate; and
the end-capping agent is selected from the group consisting of allyl alcohol and 2-hydroxyethyl-methacrylate.

The reaction of the said terminal hydroxyl groups or the said terminal carboxyl groups with a functionalizer being a diisocyanate compound and subsequently with an end-capping agent having ethylenic unsaturation, introduces urethane characteristics and increases the crosslink density of a given polyester, but does not adversely affect the weatherability and sun light resistance.

Preferably,
the functionalizer does not bear the ethylenic unsaturation and is selected from the group consisting of alicyclic polyepoxides, aromatic polyepoxides and aliphatic polyepoxides; and
the end-capping agent is at least one unsaturated carbon acid.

More preferably,
the functionalizer does not bear the ethylenic unsaturation and is selected from the group consisting of hydrogenated bisphenol A epoxy (i.e. diglycidyl hydrogenated bisphenol A) and bisphenol A epoxy (i.e. diglycidyl bisphenol A); and
the end-capping agent is selected from the group consisting of acrylic acid and methacrylic acid.

In another preferred embodiment of the unsaturated polyester resin component the product obtained by reacting a monomer mixture is end-capped with isopherone diisocyanate as the functionalizer and 2-hydroxyethyl-methacrylate as the end-capping agent.

Preferably, the reaction of the said terminal hydroxyl groups or the said terminal carboxyl groups comprises reacting the product obtained by reacting a monomer mixture with a functionalizer and

a catalyst and/or

an inhibitor.

Preferably, the optional present catalyst is selected from the group consisting of tetramethylammonium chloride, tetramethylammonium bromide and dibutyltindilaurate.

Preferably, the optional present inhibitor is 4-hydroxy-2,2,6,6-tetramethylpiperidin-1-oxyl (4-hydroxy-TEMPO) or butylated hydroxytoluene (BHT).

Another aspect of the invention relates to a prepromoted unsaturated polyester resin system for the preparation of engineered stone, which system comprises
(i) an unsaturated polyester resin component according to the invention as described above;
(ii) a metal catalyst capable of catalyzing curing of said unsaturated polyester resin component; preferably a zinc salt of a carboxylic acid, more preferably a zinc salt of a C₁₋₂₀ carboxylic acid, still more preferably a zinc salt of a C₆₋₁₂ carboxylic acid, most preferably zinc octanoate;
(iii) a quaternary ammonium salt; preferably a benzyl-N,N,N-trialkylammonium salt or a N,N,N,N-tetraalkylammonium salt; and
(iv) optionally, one or more additives selected from the group consisting of reactive diluents, accelerators, co-promoters, dispersing agents, UV absorbers, stabilizers, inhibitors and rheology modifiers.

All preferred embodiments of the unsaturated polyester component according to the invention that have been defined above analogously also apply to the prepromoted unsaturated polyester resin system according to the invention and thus, are not repeated hereinafter.

For the purpose of the invention, a “prepromoted” resin already contains the metal catalyst as promoter, but not yet the initiator (peroxide) for the radical reaction that causes curing. The prepromoted resin has long shelf-life and may be marketed as precursor. The initiator (peroxide) is then shortly added before the prepromoted resin is employed in the production of the final product, i.e. of the engineered stone.

The prepromoted unsaturated polyester resin system according to the invention comprises a metal catalyst capable of catalyzing curing of said unsaturated polyester resin component.

Preferably, the metal catalyst that is contained in the prepromoted unsaturated polyester resin system according to the invention comprises zinc or copper, preferably in form of a zinc salt, a copper salt or a cobalt salt.

In a preferred embodiment, the metal catalyst is a zinc salt. The zinc salts of carboxylic acids are preferred. Non-limiting examples of typical zinc salts include the zinc salts of C₁₋₂₀ carboxylic acids and polycarboxylic acids, preferably zinc salts of C₆₋₁₂ carboxylic acid and polycarboxylic acids, including zinc acetate, zinc propionate, zinc butyrate, zinc pentanoate, zinc hexanoate, zinc heptanoate, zinc 2-ethyl hexanoate, zinc octanoate, zinc nonanoate, zinc decanoate, zinc neodecanoate, zinc undecanoate, zinc undecenylate, zinc dodecanoate, zinc palmitate, zinc stearate, zinc oxalate, and zinc naphthenate. Other zinc salts useful herein include the zinc salts of amino acids such as zinc alanine, zinc methionine, zinc glycine, zinc asparagine, zinc aspartine, zinc serine, and the like. Other zinc salts include zinc citrate, zinc maleate, zinc benzoate, zinc acetylacetonate, and the like. Other zinc salts include zinc chloride, zinc sulfate, zinc phosphate, and zinc bromide. The zinc chalcogens and zinc oxide can also be used. Zinc octoanate (zinc octoate) is particularly preferred.

In another preferred embodiment, the metal catalyst is a copper salt. Preferred copper salts are copper (I) salts or copper (II) salts. Preferred copper salts include but are not limited to copper acetate, copper octanoate, copper naphthenate, copper acetylacetonate, copper chloride or copper oxide.

In another preferred embodiment, the metal catalyst is cobalt octoate.

The content of the metal catalyst, preferably zinc octanoate or cobalt octoate, relative to the total weight of the prepromoted unsaturated polyester resin system according to the invention, is preferably within the range of from about 0.001 wt.-% to about 1 wt.-%, more preferably about 0.01 wt.-% to about 0.1 wt.-%. Preferably, the content of the metal catalyst, preferably zinc octanoate or cobalt octoate, relative to the total weight of the prepromoted unsaturated polyester resin system according to the invention, is within the range of about 0.20±0.15 wt.-%, more preferably about 0.20±0.10 wt.-%, most preferably about 0.20±0.05 wt.-%.

The content of the metal catalyst, preferably zinc octanoate or cobalt octoate, relative to the total weight of the formable composition according to the invention, is preferably within the range of from about 0.0001 wt.-% to about 0.1 wt.-%, more preferably about 0.001 wt.-% to about 0.01 wt.-%. Preferably, the content of the metal catalyst, preferably zinc octanoate or cobalt octoate, relative to the total weight of the formable composition according to the invention, is within the range of about 0.020±0.015 wt.-%, more preferably about 0.020±0.010 wt.-%, most preferably about 0.020±0.005 wt.-%.

The prepromoted unsaturated polyester resin system according to the invention comprises a quaternary ammonium salt, preferably a benzyl-N,N,N-trialkylammonium salt or a N,N,N,N-tetraalkyl ammonium salt.

Preferably, the quaternary ammonium salt that is contained in the prepromoted unsaturated polyester resin system according to the invention is a benzyl-N,N,N-trialkylammonium salt or a N,N,N,N-tetraalkylammonium salt. Preferred representatives include but are not limited to benzyl-N,N,N-trimethylammonium salts such as benzyl-N,N,N-trimethylammonium chloride; and benz-alkonium chlorides such as benzyl-N,N,N—C₂₋₂₀-alkyl-dimethyl-ammonium salts, e.g. benzyl-N,N,N—C₂₋₂₀-alkyl-dimethyl-ammonium chloride, N,N—C₂₋₂₀-dialkyl-N,N-dimethyl ammonium salts, and the mixtures thereof.

The content of the quaternary ammonium salt, relative to the total weight of the prepromoted unsaturated polyester resin system according to the invention, is preferably within the range of from about 0.001 wt.-% to about 5 wt.-%, more preferably about 0.01 wt.-% to about 0.5 wt.-%. Preferably, the content of the quaternary ammonium salt, relative to the total weight of the prepromoted unsaturated polyester resin system according to the invention, is within the range of about 0.20±0.15 wt.-%, more preferably about 0.20±0.10 wt.-%, most preferably about 0.20±0.05 wt.-%.

The prepromoted unsaturated polyester resin system according to the invention may comprise one or more additives selected from the group consisting of reactive diluents, accelerators, co-promoters, dispersing agents, UV absorbers, stabilizers, inhibitors and rheology modifiers. Suitable additives are known to the skilled person. In this regard it can be referred to e.g. Ernest W. Flick, Plastics Additives, An Industrial Guide, 3rd ed. 2002, William Andrew Publishing.

The total content of optional additives, relative to the total weight of the prepromoted unsaturated polyester resin system according to the invention, is preferably within the range of from about 0.001 wt.-% to about 10 wt.-%, more preferably about 0.01 wt.-% to about 5 wt.-%.

Preferably, the prepromoted unsaturated polyester resin system comprises a reactive diluent selected from the group consisting of styrene, substituted styrene, mono-, di- and polyfunctional esters of monofunctional ethylenically unsaturated acids with alcohols or polyfunctional alcohols (e.g. methacrylate or methyl methacrylate) and/or mono-, di- and polyfunctional esters of unsaturated monofunctional alcohols with carboxylic acids or their derivatives.

Preferably, the reactive diluent comprises styrene.

In another embodiment the reactive diluent is mono-methacrylate and/or di-methacrylate.

In yet another preferred embodiment, the reactive diluent comprises a mixture of styrene with a mono-methacrylate, di-methacrylate and/or triacrylate. Preferably, styrene is mixed with butyl methacrylate, 1,3 butyleneglycol dimethacrylate and/or trimethylolpropopane triacrylate.

Preferably, the content of reactive diluent is in the range of 30±25 wt.-% relative to the total weight of the polyester resin system, more preferably about 30±20 wt.-%, or about 30±15 wt.-%, or about 30±10 wt.-%, or about 30±8 wt.-%, or about 30±7 wt.-%, or about 30±6 wt.-%, or about 30±5 wt.-%, or about 30±4 wt.-%, or about 30±3 wt.-%, or about 30±2 wt.-%, or about 30±1 wt.-% in each case relative to the total weight of the prepromoted unsaturated polyester resin system.

In other preferred embodiments, the content of reactive diluent is within the range of about 40±15 wt.-%, or about 40±13 wt.-%, or about 40±10 wt.-%, or about 40±5 wt.-%, or about 20±19 wt.-%, or about 20±18 wt.-%, or about 20±16 wt.-%, or about 20±15 wt.-%, or about 20±14 wt.-%, or about 20±13 wt.-%, or about 20±12 wt.-%, or about 20±10 wt.-%, or about 20±9 wt.-%, or about 20±8 wt.-%, or about 20±7 wt.-%, or about 20±6 wt.-%, or about 20±5 wt.-%, or about 20±4 wt.-%, or about 20±3 wt.-%, or about 20±2 wt.-%, or about 10±9 wt.-%, or about 10±6 wt.-%, or about 10±5 wt.-%, or about 10±4 wt.-%, or about 10±3 wt.-%, or about 10±2 wt.-% in each case relative to the total weight of the prepromoted unsaturated polyester resin system.

More preferred, the content of reactive diluent is within the range of about 15±10 wt.-%, more preferably about 15±9 wt.-%, still more preferably about 15±8 wt.-%, yet more preferably about 15±7 wt.-%, even more preferably about 15±6 wt.-%, most preferably about 15±5 wt.-% and in particular about 15±4 wt.-%, in each case relative to the total weight of the prepromoted unsaturated polyester resin system.

Preferably, the reactive diluent essentially consists of styrene and the content of reactive diluent is in the range of 30±25 wt.-%, more preferably about 30±20 wt.-%, or about 30±15 wt.-%, or about 30±10 wt.-%, or about 30±8 wt.-%, or about 30±7 wt.-%, or about 30±6 wt.-%, or about 30±5 wt.-%, or about 30±4 wt.-%, or about 30±3 wt.-%, or about 30±2 wt.-%, or about 30±1 wt.-% in each case relative to the total weight of the prepromoted unsaturated polyester resin system.

Preferably, the reactive diluent comprises a mixture of styrene and one or more monomers selected from the group consisting of a mono-methacrylate, di-methacrylate and triacrylate, wherein the content of reactive diluent is in the range of 30±25 wt.-%, more preferably about 30±20 wt.-%, or about 30±15 wt.-%, or about 30±10 wt.-%, or about 30±8 wt.-%, or about 30±7 wt.-%, or about 30±6 wt.-%, or about 30±5 wt.-%, or about 30±4 wt.-%, or about 30±3 wt.-%, or about 30±2 wt.-%, or about 30±1 wt.-% in each case relative to the total weight of the prepromoted unsaturated polyester resin system.

In a preferred embodiment, the reactive diluent does not comprise an ethylenically unsaturated monomer bearing an aromatic group.

In another preferred embodiment, the reactive diluent comprises an ethylenically unsaturated monomer bearing an aromatic group, such as styrene, whereas the total content of said an ethylenically unsaturated monomer bearing an aromatic group is preferably not more than 50 mole.-%, more preferably not more than 45 mole.-%, still more preferably not more than 40 mole.-%, yet more preferably not more than 35 mole.-%, even more preferably not more than 30 mole.-%, most preferably not more than 25 mole.-%, and in particular not more than 20 mole.-%, in each case relative to the total content of the reactive diluent.

In another preferred embodiment of the prepromoted unsaturated polyester resin system the unsaturated polyester resin component is aromatic and the reactive diluent is not the major source of aromatic unsaturation in the prepromoted unsaturated polyester resin system. The optionally present additives in the prepromoted unsaturated polyester resin system may also comprise aromatic compounds.

In a preferred embodiment of prepromoted unsaturated polyester resin system according to the invention, the unsaturated polyester resin component is aliphatic (i.e. is derived from monomers bearing no aromatic groups) and the reactive diluent does not comprise an ethylenically unsaturated monomer bearing an aromatic group.

In another preferred embodiment of prepromoted unsaturated polyester resin system according to the invention, the unsaturated polyester resin component is aliphatic (i.e. is derived from monomers bearing no aromatic groups) and the reactive diluent comprises an ethylenically unsaturated monomer bearing an aromatic group.

In still another preferred embodiment of prepromoted unsaturated polyester resin system according to the invention, the unsaturated polyester resin component is aromatic (i.e. is inter alia derived from a monomer bearing an aromatic group) and the reactive diluent does not comprise an ethylenically unsaturated monomer bearing an aromatic group.

In yet another preferred embodiment of prepromoted unsaturated polyester resin system according to the invention, the unsaturated polyester resin component is aromatic (i.e. is inter alia derived from a monomer bearing an aromatic group) and the reactive diluent comprises an ethylenically unsaturated monomer bearing an aromatic group.

Inhibitors may be contained in the prepromoted unsaturated polyester resin system to lengthen the gel time (pot life). Inhibitors are useful when very long gel times are required or when resin is curing quickly due to high temperatures. Some common inhibitors include tertiary butyl catechol, hydroquinone, and toluhydroquinone.

Fillers may be contained in the prepromoted unsaturated polyester resin system. Alumina trihydrate may be contained e.g. to improve flame retardancy and reduce smoke emissions. Calcium carbonate, talc and kaolin clays may be contained e.g. to increase the stiffness. Silicon carbide and/or aluminum oxide may be contained in the prepromoted unsaturated polyester resin system e.g. to reduce liner deterioration caused by abrasion.

The prepromoted unsaturated polyester resin system may further comprise dispersing agents, which are chemicals that aid in the dispersion of solid components in the resin composition, i.e. enhance the dispersion of solid components in the unsaturated resin. Useful dispersing agents include but are not limited to copolymers comprising acidic functional groups like BYK®-W 996 available for Byk USA, Inc., Wallingford, Conn., U.S.A. (“Byk”), unsaturated polycarboxylic acid polymer comprising polysiloxane copolymer, like BYK®-W 995 available from Byk, copolymer comprising acidic functional groups, like BYK®-W 9011 available from Byk, copolymer comprising acidic functional groups, like BYK®-W 969 available from Byk and alkylol ammonium salt of an acidic polyester. Combinations of dispersing agents may be used.

The prepromoted unsaturated polyester resin system can comprise a co-promoter to enhance cure. Co-promoters useful in the invention include 2,4-petendione (“2,4-PD”), 2-acetylbutyrolactone, ethyl acetoacetonate, n,n-diethyl acetoacetamide and the like, and combinations thereof.

The prepromoted unsaturated polyester resin system may comprise a coupling agent. Coupling agents useful in the invention include but are not limited to silanes, e.g. 3-trimethoxy-silyl-propyl-methacrylate or vinyl-trimethoxy-silane, and silane modified polyethylene glycol.

The prepromoted unsaturated polyester resin system may also comprise rheology modifiers. Typical rheology modifiers include fumed silica, organic clay and combinations thereof.

In addition, the prepromoted unsaturated polyester resin system may comprise other conventional additives such as synergist agents. These synergist agents include polysorbate 20 (Tween 20), polyhydroxycarboxylic acid esters, such as BYK®-R605 and R606 available from Byk and the like, and combinations thereof.

Another aspect of the invention relates to a formable composition for the preparation of engineered stone comprising

(A) a prepromoted unsaturated polyester resin system according to the invention as described above;
(B) an inorganic particulate material; and
(C) a peroxide component.

All preferred embodiments of the unsaturated polyester component according to the invention and of the prepromoted unsaturated polyester resin system according to the invention that have been defined above analogously also apply to the formable composition according to the invention and thus, are not repeated hereinafter.

The formable composition according to the invention has the advantage that it can be processed on conventional plants for the manufacture of engineered stone without any adaptations. Furthermore, as the unsaturated polyester resin system contained in the formable composition is prepromoted already, the final manufacturing process merely requires the mixing of (A), (B) and (C) with one another and thus, facilitates the process compared to conventional processes requiring separate addition of metal catalyst (promoter).

The formable composition according to the invention comprises an inorganic particulate material, preferably silicon dioxide, more preferably quartz and/or cristobalite. Typically, the inorganic particulate material is the main constituent of the formable composition and provides the engineered stone with the desired appearance.

Preferably, the inorganic particulate material is made from stone, e.g. crushed stone.

In a preferred embodiment, the inorganic particulate material, preferably the silicon dioxide, more preferably fine quartz has an average particle size in the range of from about 0.045 to about 0.6 mm, more preferred in the range of from about 0.3 to about 0.6 mm, still more preferred in the range of from about 0.1 to about 0.3 mm.

In another preferred embodiment, the inorganic particulate material comprises a mixture of silicon dioxide particles with an average particle size of about 0.045 mm, and particles with an average particle size in the range of from about 0.3 to about 0.6 mm and particles with an average particle size in the range of from about 0.1 to about 0.3 mm.

Suitable methods for determining the average particle size and particle size distribution of an inorganic particulate material are known to the skilled person such as laser light scattering according to ASTM C1070-01(2014) or electric sensing zone technique according to ASTM C690-09.

Preferably, the weight content of the inorganic particulate material is about 70 wt.-% to about 99.9 wt.-%, more preferably about 80 wt.-% to about 95 wt.-%, relative to the total weight of the formable composition. Preferably, the content of the inorganic particulate material is within the range of about 90±7 wt.-%, more preferably about 90±6 wt.-%, still more preferably about 90±5 wt.-%, yet more preferably about 90±4 wt.-%, even more preferably about 90±3 wt.-%, most preferably about 90±2 wt.-%, and in particular about 90±1 wt.-%, relative to the total weight of the formable composition.

In another preferred embodiment the weight content of the inorganic particulate material is not more than about 90 wt.-% relative to the total weight of the formable composition.

In order to induce curing of the formable composition according to the invention, a radical initiator is needed. The initiator generates free radicals reacting with the ethylenic unsaturations of the unsaturated polyester resin component, thereby causing cross-linking of the polymer network. Preferred peroxides are organic peroxides that work together with the metal catalyst (promoters) to initiate the chemical reaction that causes a resin to gel and harden. The amount of time from which the peroxide is added until the resin begins to gel is referred to as the “gel time” or “pot life”. Peroxide and metal catalyst levels can be adjusted, to a certain extent, to shorten or lengthen the gel time and accommodate both high and low temperatures. If a longer gel time is required, inhibitors can be added.

Preferably, the peroxide component is a hydroperoxide and/or an organic peroxide, more preferably an organic hydroperoxide.

Preferably, the peroxide component is selected from the group consisting of methyl ethyl ketone peroxide (MEKP), methyl isobutyl ketone peroxide (MIKP), benzoyl peroxide (BPO), tert-butyl peroxibenzoate (TBPB), cumene hydroperoxide (CHP), and mixtures thereof.

Benzoyl peroxide (BPO) and/or tert-butyl peroxibenzoate (TBPB) are particularly preferred.

Preferably, the content of the peroxide component, preferably cumene hydroperoxide and/or methyl isobutyl ketone peroxide, is about 0.001 wt.-% to about 0.1 wt.-%, more preferably about 0.005 wt.-% to about 0.05 wt.-%, relative to the total weight of the formable composition. Preferably, the content of the peroxide component, preferably cumene hydroperoxide and/or methyl isobutyl ketone peroxide, relative to the total weight of the formable composition according to the invention, is within the range of about 0.20±0.15 wt.-%, more preferably about 0.20±0.10 wt.-%, most preferably about 0.20±0.05 wt.-%.

In a preferred embodiment the weight content of the prepromoted unsaturated polyester resin system is about 0.1 wt.-% to about 30 wt.-%, relative to the total weight of the formable composition; and/or the weight content of the inorganic particulate material is about 70 wt.-% to about 99.9 wt.-%, relative to the total weight of the formable composition.

Preferably, the content of the prepromoted unsaturated polyester resin system is about 0.1 wt.-% to about 30 wt.-%, more preferably about 5 wt.-% to about 20 wt.-%, relative to the total weight of the formable composition. Preferably, the content of the prepromoted unsaturated polyester resin system is within the range of about 10±7 wt.-%, more preferably about 10±6 wt.-%, still more preferably about 10±5 wt.-%, yet more preferably about 10±4 wt.-%, even more preferably about 10±3 wt.-%, most preferably about 10±2 wt.-%, and in particular about 10±1 wt.-%, relative to the total weight of the formable composition.

In preferred embodiments, the weight content of the prepromoted unsaturated polyester resin system is not more than about 10 wt.-%, more preferably not more than about 9.5 wt.-%, still more preferably not more than about 9 wt.-%, yet more preferably not more than about 8.5 wt.-%, even more preferably not more than about 8 wt.-%, most preferably not more than about 7.5 wt.-% and in particular not more than about 6 wt.-%, in each case relative to the total weight of the formable composition.

Preferably, the formable composition according to the invention has a pot life of at least about 30 minutes, more preferably at least about 1 hour, still more preferably at least about 1.5 hours and most preferably at least about 2 hours. Preferably, at 40° C. the pot life of the formable composition according to the invention, measured after mixing components (A) and (C) and optionally (B), is within the range of about 4.3±3.5 hours, more preferably about 4.3±3.0 hours, still more preferably about 4.3±2.5 hours, yet more preferably about 4.3±2.0 hours, even more preferably about 4.3±1.5 hours, most preferably about 4.3±1.0 hours, and in particular about 4.3±0.5 hours.

Preferably, the formable composition according to the invention has a polymerization time at 110° C. of at least about 30 minutes, more preferably at least about 1 hour. Preferably, at 110° C. the polymerization time of the formable composition according to the invention, is within the range of about 60±35 minutes, more preferably about 60±30 minutes, still more preferably about 60±25 minutes, yet more preferably about 60±20 minutes, even more preferably about 60±15 minutes, most preferably about 60±10 minutes, and in particular about 60±5 minutes.

Still another aspect of the invention relates to a method for the preparation of a unsaturated polyester resin component according to the invention as described above comprising the steps of

(a) reacting a monomer mixture comprising
(i) a fumaric acid component;
(ii) a polyfunctional alcohol component;
(iii) optionally, a polycarboxylic acid component differing from the fumaric acid component;
(iv) optionally, a monocarboxylic acid component; and
(v) optionally, a monofunctional alcohol component;
wherein
   the molar content of the (i) fumaric acid component is within the range of from 5.0 to 50 mol.-%; and
   the molar content of the (ii) polyfunctional alcohol component is within the range of from 20 to 90 mol.-%;
wherein said molar content in each case is relative to the total molar content of the (i) fumaric acid component, the (ii) polyfunctional alcohol component, the (iii) optionally present polycarboxylic acid component, the (iv) optionally present monocarboxylic acid component, and (v) the optionally present monofunctional alcohol component in the monomer mixture; and
   (b) optionally, end-capping the product of step (a).

Preferably, the temperature of step (a) reacting a monomer mixture lies in the range of about 100 to about 230° C.

Preferably, the method for the preparation of a unsaturated polyester resin component according to the invention as described above comprises the steps of
(a) heating the monomer mixture slowly to a temperature of about 120° C. with agitation until a homogeneous mixture is obtained;
(b) further slowly heating of the thus obtained homogenous mixture to a temperature of about 190° C.;
(c) removing water and sparging with nitrogen
(d) keeping the distillation temperature at a temperature of 100° C. throughout the sparging and the removal of water;
(e) after an acid value of up to 4 is reached cooling of the mixture to a temperature of about 80° C. and sparging with air;
(f) adding of inhibitors.

A skilled person recognizes that the polyester backbone may also contain minor amounts of maleic acid, i.e. the isomer of fumaric acid. Further, during the polymerization of the monomers water is formed which may hydrolyze fumaric acid to malic acid. Preferably, the method for the preparation of an unsaturated polyester resin component according to the invention comprises steps which lead to a low content of malic acid and/or maleic acid, such as for example the removal of water during synthesis.

Still another aspect of the invention relates to an unsaturated polyester resin component that is obtainable by the above method.

Another aspect of the invention relates to a method for the preparation of a prepromoted unsaturated polyester resin system according to the invention as described above comprising the step of mixing
(i) an unsaturated polyester resin component according to the invention as described above;
(ii) a metal catalyst capable of catalyzing curing of said unsaturated polyester resin component;
(iii) a quaternary ammonium salt; and
(iv) optionally, one or more additives selected from the group consisting of reactive diluents, accelerators, co-promoters, dispersing agents, UV absorbers, stabilizers, inhibitors and rheology modifiers.

Still another aspect of the invention relates to an unsaturated polyester resin system that is obtainable by the above method.

Still another aspect of the invention relates to a method for the preparation of a formable composition for the preparation of engineered stone according to the invention as described above comprising the step of mixing

(A) a prepromoted unsaturated polyester resin system according to the invention as described above;
(B) an inorganic particulate material; and
(C) a peroxide component.

Still another aspect of the invention relates to formable composition that is obtainable by the above method.

Still another aspect of the invention relates to a method for the preparation of engineered stone comprising the steps of

(a) providing a formable composition according to the invention as described above;
(b) forming the composition prepared in step (a) into a desired shape; and
(c) allowing the composition formed in step (b) to cure.

Methods for forming the formable composition into a desired shape according to step (b) are known to a skilled person. Preferred methods according to the invention include but are not limited to vibro-compaction under vacuum.

Still another aspect of the invention relates to engineered stone obtainable by the method according to the invention as described above.

All preferred embodiments of the unsaturated polyester component according to the invention, of the prepromoted unsaturated polyester resin system according to the invention, and of the formable composition according to the invention that have been defined above analogously also apply to the methods according to the invention as well as to the products obtainable by said methods and thus, are not repeated hereinafter.

Another aspect of the invention relates to the use of

an unsaturated polyester resin component according to the invention as described above;

a prepromoted unsaturated polyester resin system according to the invention as described above; or

a formable composition according to the invention as described above

for the preparation of engineered stone.

All preferred embodiments of the unsaturated polyester component according to the invention, of the prepromoted unsaturated polyester resin system according to the invention, of the formable composition according to the invention, of the methods according to the invention as well as of the products obtainable by said methods that have been defined above analogously also apply to the uses according to the invention and thus, are not repeated hereinafter.

The following examples further illustrate the invention but are not to be construed as limiting its scope.

### EXAMPLES 1 AND 2 (PREPARATION OF AN UNSATURATED POLYESTER RESIN)

Unsaturated polyester resin suitable for end-capping with urethane methacrylate was prepared from the following monomers:

| components (mol.-%) | example 1 | example 2 |
|---|---|---|
| ethylene glycol | 28.3 | 28.3 |
| neopentyl glycol | 28.3 | 28.3 |
| adipic acid | 17.3 | 29.0 |
| fumaric acid | 26.2 | 14.5 |

The monomers were charged to a resin kettle equipped with a Thermocouple, a mechanical stirrer, a fractionating column, a distillation head, a condenser and a nitrogen sparge. The mixture of each example was heated slowly to 120° C. with agitation until a homogeneous mixture was obtained. The homogeneous mixture was heated slowly to 190° C. removing water and then sparged with nitrogen, whereas the rate of sparge was maintained such that the distillation temperature was kept at 100° C. throughout the removal of water. The acid value and cone and plate viscosity were monitored during the reaction. When the mixture reached an acid value in the range of 0 to 4 it was cooled down to about 80° C. At this time the nitrogen sparge was changed to air sparge and 200 ppm hydroquinone inhibitor was added followed by methyl methacrylate to adjust the nonvolatile component to 80-90%. The resin was then cooled down to room temperature.

The acid and hydroxyl values and the molecular weight of the polymers were determined with standard methods. The results are shown in the table here below:

| | example 1 | example 2 |
|---|---|---|
| acid number | 3.3 | 3.3 |
| OH value | 120 | 87 |
| Mn (g/mol) | 1,362 | 1,481 |
| Mw (g/mol) | 2,175 | 2,579 |
| Pdi | 1.6 | 1.74 |

### EXAMPLES 3 AND 4 (URETHANE METHACRYLATE END-CAPPING OF THE UNSATURATED POLYESTER RESIN)

The resin of example 1 was end-capped with the components which are shown in the table here below to obtain example 3:

| components (g) | example 3 |
|---|---|
| unsaturated resin of example 1 (N.V. 89.3% in MMA) | 523.5 |
| MMA | 180 |
| IPDI | 222.3 |
| 4-hydroxy-TEMPO | 0.4 |
| Dabco-T12 | 0.12 |
| HEMA | 143.1 |

The resin of example 2 was end-capped with the components which are shown in the table here below to obtain example 4:

| components (g) | example 4 |
|---|---|
| unsaturated resin of example 2 (N.V. 89.6% in MMA) | 1,583.27 |
| MMA | 550.00 |
| IPDI | 595.76 |
| 4-hydroxy-TMPO | 1.10 |
| 25% HQ solution | 0.44 |
| Dabco-T12 | 0.26 |
| HEMA | 314.86 |

The resins were end-capped according to the following method: Under a nitrogen blanket a resin flask was charged with resin solution of example 1 or 2 respectively in MMA. MMA, isophorone diisocyanate (IPDI) and 4-hydroxy-2,2,6,6-tetramethylpiperidin-1-oxyl (4-hydroxy-TEMPO) and dibutyltindilaurate catalyst (DABCO T12) were added. The exothermic reaction was allowed to take place keeping the reaction temperature below 65° C. using external cooling if needed. The reaction mixture was then heated to 65° C. for additional 90 minutes. At the end of 90 minutes, 2-hydroxyethyl methacrylate (HEMA) was added and the exothermic reaction was allowed to take place keeping the temperature below 70° C. The reaction mixture was then heated at 70° C. until all the isocyanate groups had reacted. The reaction was followed by FTIR, NCO peak.

The molecular weight of the end-capped resins was measured:

| | example 3 | example 4 |
|---|---|---|
| Mn (g/mol) | 2,282 | 2,672 |
| Mw (g/mol) | 5,320 | 5,824 |
| Pdi | 2.33 | 2.18 |

### EXAMPLE 5 (ALTERNATIVE URETHANE METHACRYLATE END-CAPPING OF THE UNSATURATED POLYESTER RESIN)

Alternatively, end-capping of the unsaturated polyester resin can be done using the following components and procedure.

| components (g) | example 5 |
|---|---|
| unsaturated resin of example 1 (N.V. 89.3% in MMA) | 532.5 |
| MMA | 180 |
| IPDI | 222.3 |
| BHT | 0.1 |
| Dabco-T12 | 0.12 |
| HEMA (1^{st} addition) | 143 |
| HEMA (2nd addition) | 13 |

Under nitrogen blanket, a resin flask was charged with MMA and isophorone diisocyanate (IPDI), butyl hydroxyl toluene (BHT) and dibutyltindilaurate catalyst (DAB^{º}CO T12). This mixture was then heated to 50° C. and 2-hydroxyethy methacrylate (HEMA) was added slowly maintaining the reaction mixture below 65° C. After the HEMA addition was completed, the reaction temperature was maintained at 65° C. for an additional 90 minutes. The reaction mixture was then cooled down to 60° C. and resin of example 1 was added. The exothermic reaction was allowed to take place keeping the reaction temperature below 80° C. The reaction temperature was then maintained at 80° C. for 4 hours at which time an additional HEMA was added. The reaction was followed by FTIR until all the isocyante groups had reacted.

### EXAMPLE 6: (PREPARATION OF UNSATURATED POLYESTER RESIN WITHOUT END-CAPPING)

Unsaturated polyester resin was prepared from the following monomers:

| components (mol.-%) | example 6 |
|---|---|
| 1,3-butanal | 25.86 |
| neopentyl glycol | 25.33 |
| adipic acid | 15.38 |
| fumaric acid | 33.43 |

The monomers were charged to a resin kettle equipped with a Thermocouple, a mechanical stirrer, a fractionating column, a distillation head, a condenser and a nitrogen sparge. The mixture of example 6 was heated slowly to 120° C. with agitation until a homogeneous mixture was obtained. To this mixture, 35 ppm hydroquinone inhibitor, 0.033% phosphoric acid and 0.021% oxalic acid catalyst were added. The homogeneous mixture was heated slowly to 190° C. removing water and then sparged with nitrogen, whereas the rate of sparge was maintained such that the distillation temperature was kept at 100° C. throughout the removal of water. The acid number and cone and plate viscosity were monitored during the reaction. When the target acid value of 14 to 20 and viscosity of 2.9 to 3.9 P were reached, the reaction mixture was cooled down to 80 C and an additional 30 ppm of hydroquinone inhibitor was added and the air sparge started. Styrene monomer was added and the resin was cooled down to room temperature.

The acid value, viscosity and the molecular weight of example 6 were determined with standard methods. The results are shown in the table here below:

| | example 6 |
|---|---|
| acid number | 18 |
| plastic viscosity C&P at 150° C. (P) | 2.9 |
| Mn (g/mol) | 2,789 |
| Mw (g/mol) | 6,832 |
| Pdi | 2.45 |

### EXAMPLES 7, 8 AND 9 (PREPARATION OF ENGINEERED STONE BASED ON END-CAPPED RESIN OF EXAMPLE 3 AND UNCAPPED RESIN OF EXAMPLE 6 AND WITH AROPOL DRL 085)

A formulation was prepared with the following components:

| component (Mol.-%) | example 7 |
|---|---|
| resin of example 1 | 58.75 |
| MMA | 41.25 |
| BPO 50% | 2 |
| TBPB | 0.1 |
| Vinyl-trimethoxy-silane | 0.2 |

A corresponding example 8 was prepared with the resin of example 6 (not end-capped).

The amounts of fillers and pigments which were added to the examples 7 and 8 are shown in the following table. Further, an engineered stone slab was prepared with a comparative resin.

| | | | comparative example 9 |
|---|---|---|---|
| components (wt.-%) | example 7 | example 8 | Aropol DRL 085 |
| formulation | 10 | 10 | 10 |
| quartz fillers 0.3-0.6 mm | 25 | 25 | 25 |
| quartz fillers 0.1-0.3 mm | 35 | 35 | 35 |
| quartz fillers 0.045 mm | 30 | 30 | 30 |
| TiO₂white slabs | 2 | 2 | 2 |
| only part per 100) | | | |

The weathering properties and the UV-resistance of the obtained engineered stone slabs of examples 7 to 9 were investigated by exposing the stone slabs to outdoor conditions in Arizona for one year. The results of the measurements of color changes of the stone slabs after one year exposure to outdoor conditions in Arizona are summarized in the table below:

| | | | comparative example 9 |
|---|---|---|---|
| | example 7 | example 8 | Aropol DRL 085 |
| white slabs | | | |
| db | −0.26 | 0.37 | 1.2 |
| dE | 0.31 | 0.73 | 1.57 |
| black slabs | | | |
| db | 0.04 | −0.75 | −1.15 |
| dE | 0.4 | 2.99 | 13.53 |

The degree of color change due to weathering and UV-exposure is measured with the values “db” and “dE”. The value “db” is related to yellowing of the stone slabs, wherein an increase of the “db” value or a positive “db” value indicates that the change is to a more (darker) yellow color of the artificial stone slabs and a decrease of the “db” value or a negative “db” value indicates a change to a more blue color of the artificial stone slabs. The value “dE” relates to the total color change of the artificial stone slabs. It is always positive because of the way it is calculated, wherein a higher “dE” value indicates a more intensive change in color of the artificial stone slabs.

It becomes clear from the above comparative data that the unsaturated polyester resin according to the invention provides engineered stone having superior weathering properties and UV-resistance compared to engineered stone manufactured from conventional unsaturated polyester resins.

The white stone slab of comparative example 9 showed a considerable increase of its “db” value which was almost six times higher than the “db” value of the white stone slab of example 7 and three times higher than the “db” value of the white stone slab of example 8 prepared with the inventive resin. This means that the white stone slab of comparative example 9 turned to a more (darker) yellow color much more compared to the slabs prepared with the inventive resin.

The black stone slab of comparative example 9 showed a considerable decrease of its “db” value which was up to 28 times smaller than the “db” value of the black stone slab of example 7 and 1.5 times smaller than the “db” value of the black stone slab of example 8 prepared with the inventive resin. This means that the black stone slab of comparative example 9 turned to a blue color much more compared to the slabs comprising the inventive resin.

Further, the white and the black stone slabs prepared with the inventive unsaturated polyester resin of examples 7 and 8 showed only a rather small change of the “db” value compared to the slab of comparative example 9, meaning that the white slabs hardly turned to a more (darker) yellow color and the black slabs hardly turned to a more blue color.

Furthermore, the white and the black stone slabs prepared with the inventive unsaturated polyester resin of examples 7 and 8 showed a small total change in color, i.e. a small change of the “dE” value, compared to the stone slab prepared with conventional resin of example 9. The white stone slab of example 7 prepared with the inventive resin had a “dE” value which was about five times smaller than the “dE” value of the white stone slabs of comparative example 9. The black stone slab of example 7 prepared with the inventive resin had a “dE” value which was four times smaller than the value of the black stone slabs of comparative example 9.

### EXAMPLES 10 TO 13 (PREPARATION OF AN UNSATURATED POLYESTER RESIN)

Unsaturated polyester resin was prepared from the following monomers:

| | example 10 | | | example 11 | | |
|---|---|---|---|---|---|---|
| component | [g] | [mol] | mol. % | [g] | [mol] | mol.-% |
| propylene glycol | 1150.3 | 15.12 | 40.06 | 1150.3 | 15.12 | 40.06 |
| diethylene glycol | 470.4 | 4.43 | 11.73 | 470.4 | 4.43 | 11.73 |
| phthalic | 949.1 | 6.41 | 16.98 | 949.1 | 6.41 | 16.98 |
| anhydride | | | | | | |
| adipic acid | — | — | — | 0 | 0 | — |
| fumaric acid | 1368.4 | 11.79 | 31.23 | 1368.4 | 11.79 | 31.23 |
| benzyl alcohol | — | — | — | — | — | — |

| | example 12 | | | example 13 | | |
|---|---|---|---|---|---|---|
| component | [g] | [mol] | mol.-% | [g] | [mol] | mol.-% |
| propylene glycol | 1150.3 | 15.12 | 39.20 | 1597.7 | 21.00 | 50.53 |
| diethylene glycol | 470.4 | 4.43 | 11.49 | — | — | — |
| phthalic | 949.1 | 6.41 | 16.62 | 814.7 | 5.50 | 13.23 |
| anhydride | | | | | | |
| adipic acid | — | — | — | 255.0 | 1.74 | 4.19 |
| fumaric acid | 1368.4 | 11.79 | 30.57 | 1450.9 | 12.50 | 30.08 |
| benzyl alcohol | 88.2 | 0.82 | 2.13 | 88.2 | 0.82 | 1.97 |

The monomers, hydroquinone 25% in PGMME solution (1,391 g) and potassium acetate (0,174 g) were charged to a reactor equipped with a thermocouple, a mechanical stirrer, a fractionating column, a distillation head, a condenser and a nitrogen sparge. Agitation was started as soon as a sufficient quantity of material was in the reactor. The reaction mixture was heated to 205-210° C. removing water and then sparged with nitrogen, whereas the rate of sparge was maintained such that the distillation temperature was kept at 100° C. throughout the removal of water. The acid number (mgKOH/g, 100% solids) and cone and plate viscosity (at 125° C.) were monitored during the reaction. When the acid value of 60 to 80 was reached, vacuum was applied and increased gradually. Vacuum was maintained until the target Brookfield cone and plate viscosity (at 125° C.) and the target acid number (mgKOH/g, 100% solids) were reached. Then the vacuum was released and the reaction mixture was cooled to a temperature of 180±5° C. The thus obtained resin was diluted in styrene. The resin was dropped slowly to a thin tank, which was charged beforehand with styrene (904 g, 8.68 mol), hydroquinone 25% in propylene glycol monomethyl ether (PGMME) solution (0.27 g) and potassium (K15%) octoate (0.0035 g). During drop, thin tank temperature was maintained at maximum 80±5° C. Mixing and cooling of the thin tank was continued until temperature was decreased below 35° C.

The acid number (mgKOH/g, 100% solids), the viscosity of plastic sample (at 125° C.) and molecular weight analysis were determined with standard methods. The results are shown in the table here below:

| | example 10 | example 11 | example 12 | example 13 |
|---|---|---|---|---|
| acid number | 39 | 45 | 46 | 42 |
| (mgKOH/g, | | | | |
| 100% solids) | | | | |
| plastic | 4.5 | 3.5 | 2.1 | 3.2 |
| viscosity C&P | | | | |
| at 125° C. (P) | | | | |
| Mn (g/mol) | 1316 | 1501 | 1279 | 1473 |
| Mw (g/mol) | 3190 | 2759 | 2220 | 2774 |
| Mp (g/mol) | 2217 | 2120 | 1763 | 2029 |
| Pdi | 2.42 | 1.84 | 1.74 | 1.88 |

Further, the content of not polymerized hydroxyl components in the unsaturated polyester resin was determined. The results are shown in the table here below:

| | | | example | example |
|---|---|---|---|---|
| components (wt.-%) | example 10 | example 11 | 12 | 13 |
| free propylene glycol | ND | 2.92 | 2.64 | 2.4 |
| free diethylene glycol | ND | 1.58 | 1.44 | — |
| free benzyl alcohol | ND | — | — | 0.32 |

The content of fumaric acid and other acids in the in the unsaturated polyester resin was determined. The results are shown in the table here below:

| components | | | | |
|---|---|---|---|---|
| (wt.-%) | example 10 | example 11 | example 12 | example 13 |
| fumaric acid | 90.8 | 88.7 | 89.9 | 90 |
| maleic acid | 1.7 | 2.2 | 2.2 | 2 |
| malic acid | 7.5 | 9.1 | 7.9 | 8 |

### EXAMPLES 14 TO 25

Formulations with the resins of examples 10 to 13 were composed with the following components and the physical and thermal properties of the thus obtained resins were determined. The formulations and the test results are shown in the table here below:

| example | 14 | 15 | 16 | 17 | 18 | 19 | 20 | 21 | 22 | 23 | 24 | 25 |
|---|---|---|---|---|---|---|---|---|---|---|---|---|
| resin of example | 10 | 10 | 11 | 11 | 11 | 12 | 12 | 12 | 13 | 13 | 13 | 13 |
| content of resin (wt.-%) | 62 | 58 | 62 | 62-63 | 64.5 | 64 | 64 | 65 | 66 | 63 | 65 | 66 |
| styrene (wt.-%) | 24 | 25 | 28 | 24-25 | 35.5 | 26 | 26 | 23 | 34 | 25 | 25 | 28 |
| 1 4-butanediol dimethacrylate | 8 | 17 | 10 | 6.5 | — | 10 | 8 | — | — | 12 | 5 | — |
| (BDDMA) (wt.-%) | | | | | | | | | | | | |
| butyl methacrylate (BMA) (wt.-%) | 6 | — | — | 6 | — | — | — | 10 | — | — | 5 | 6 |
| trimethylolpropane triacrylate | — | — | — | — | — | — | 2 | 2 | — | — | — | — |
| TMPTMA (wt.-%) | | | | | | | | | | | | |
| physical properties* | | | | | | | | | | | | |
| plastic viscosity C&P at 25° C. (mPa · s) | 455** | 530** | — | 443 | 435 | 430 | 471 | 415 | 430 | 456 | 451 | 436 |
| Brookfield viscosity at 25° C. (mPa · s) | — | 492** | 394 | — | 392 | 392 | — | — | 380 | 420 | 426 | 380 |
| tensile stress at maximum load (MPa) | — | 68 | — | 69 | 68 | 66 | — | — | 67 | 67 | 65 | 61 |
| tensile stress at break (MPa) | — | 68 | — | 69 | 68 | 66 | — | — | 67 | 67 | 65 | 61 |
| tensile modulus (MPa) | — | 3797 | — | 3545 | 3700 | 3674 | — | — | 3579 | 3352 | 3194 | 3249 |
| elongation at maximum load (%) | — | 2.6 | — | 2.9 | 2.2 | 2.5 | — | — | 2.5 | 3.1 | 3.4 | 2.8 |
| elongation at break (%) | — | 2.6 | — | 2.9 | 2.2 | 2.5 | — | — | 2.5 | 3.1 | 3.4 | 2.8 |
| flexural strength (MPa) | — | 123 | — | — | 110 | 108 | — | — | 128 | 122 | 114 | 116 |
| flex modulus (MPa) | — | 3567 | — | — | 3701 | 3296 | — | — | 3620 | 3242 | 3036 | 3228 |
| thermal properties* | | | | | | | | | | | | |
| heat distortion temperature (HDT), ° C. | 66 | 75 | 75 | 63 | 79 | 68 | 63 | 51 | 73 | 66 | 61 | 61 |
| differential scanning calometry (DSC) | — | — | | — | — | | | | 5.0 | 7.9 | 6.2 | 3.9 |
| residual reactivity, RR (J/g) | | | | | | | | | | | | |
| glass transition temperature, T_{g2} (° C.) | — | — | | — | — | | | | 80 | 72 | 72 | 73 |

*Curing with 0.2% Cobalt-2-ethyl hexanoate (6%) and 2% methyl ethyl ketone peroxide for 24 hours at room temperature followed by post cure 2 hours at 90° C. For HDT, additionally post cured for 2 hours at 100° C.
** Viscosity tested at 23° C.

1. An unsaturated polyester resin component for the preparation of engineered stone,
wherein the unsaturated polyester resin component has a weight average molecular weight within the range of from 1000 g/mol to 7500 g/mol; and
wherein the unsaturated polyester resin component is obtainable by
(a) reacting a monomer mixture comprising
(i) a fumaric acid component comprising fumaric acid and/or a fumaric acid ester;
(ii) a polyfunctional alcohol component comprising at least one polyfunctional alcohol selected from the group consisting of
aromatic polyfunctional alcohols; and
aliphatic polyfunctional alcohols;
(iii) optionally, a polycarboxylic acid component comprising at least one polycarboxylic acid selected from the group consisting of
aromatic polycarboxylic acids, anhydrides or esters thereof;
saturated aliphatic polycarboxylic acids, anhydrides or esters thereof; and
unsaturated aliphatic polycarboxylic acids, anhydrides or esters thereof differing from fumaric acid and fumaric acid ester;
(iv) optionally, a monocarboxylic acid component comprising at least one monocarboxylic acid selected from the group consisting of
aromatic monocarboxylic acids, anhydrides or esters thereof; and
aliphatic monocarboxylic acids, anhydrides or esters thereof; and
(v) optionally, a monofunctional alcohol component comprising at least one monofunctional alcohol selected from the group consisting of
aromatic monofunctional alcohols, and
aliphatic monofunctional alcohols;
wherein
the molar content of the (i) fumaric acid component is within the range of from 5.0 to 50 mol.-%; and
the molar content of the (ii) polyfunctional alcohol component is within the range of from 20 to 90 mol.-%;
wherein said molar content in each case is relative to the total molar content of the (i) fumaric acid component, the (ii) polyfunctional alcohol component, the (iii) optionally present polycarboxylic acid component, the (iv) optionally present monocarboxylic acid component, and the (v) optionally present monofunctional alcohol component in the monomer mixture; and
(b) optionally, end-capping the product of step (a).

2. The unsaturated polyester resin component according to claim 1, wherein
the (i) fumaric acid component is the only component in the monomer mixture which comprises an ethylenic unsaturation; and/or
the unsaturated polyester resin component is aliphatic or aromatic.

3. The unsaturated polyester resin component according to claim 1 or 2, wherein the product of step (a) has
an acid value within the range of from 2 to 50; and/or
a hydroxyl-value within the range of from 60 to 150.

4. The unsaturated polyester resin component according to any of the preceding claims, wherein
the polyfunctional alcohol component comprises a mixture of at least two saturated aliphatic polyfunctional alcohols; and/or
the optionally present polycarboxylic acid component comprises at least one saturated aliphatic polycarboxylic acid, anhydride or ester thereof.

5. The unsaturated polyester resin component according to claim 4, wherein
the at least two saturated aliphatic polyfunctional alcohols are selected from the group consisting of ethylene glycol, diethylene glycol, neopentyl glycol, propylene glycol and 1,4-butanediol; and/or
the at least one saturated aliphatic polycarboxylic acid, anhydride or ester thereof is adipic acid, adipic acid anhydride or an adipic acid ester.

6. The unsaturated polyester resin component according to claim 4 or 5, wherein the molar ratio of the at least two saturated aliphatic polyfunctional alcohols is within the range of 4:1 to 1:4.

7. The unsaturated polyester resin component according to any of the preceding claims, wherein
the molar content of the fumaric acid component is within the range of 23±10 mole.-%;
the molar content of the polyfunctional alcohol component is within the range of 55±15 mole.-%; and
the molar content of the optionally present polycarboxylic acid component is within the range of range of 20±10 mole.-%;
wherein said molar content in each case is relative to the total molar content of the (i) fumaric acid component, the (ii) polyfunctional alcohol component, the (iii) optionally present polycarboxylic acid component, the (iv) optionally present monocarboxylic acid component, and the (v) optionally present monofunctional alcohol component in the monomer mixture.

8. The unsaturated polyester resin component according to any of the preceding claims, wherein the molar content of the fumaric acid component in the monomer mixture is in the range of from 5 to 95 mole.-%, wherein said molar content is relative to the total molar content of the (i) fumaric acid component, the (iii) optionally present polycarboxylic acid component, and the (iv) optionally present monocarboxylic acid component.

9. The unsaturated polyester resin component according to any of the preceding claims, which is end-capped with moieties comprising ethylenic unsaturations.

10. The unsaturated polyester resin component according to claim 9, which is obtainable by steps (a) and (b), wherein step (b) comprises reacting the terminal hydroxyl groups or the terminal carboxyl groups of the product of step (a) with a functionalizer bearing a functional group capable of reacting with said terminal hydroxyl groups or said terminal carboxyl groups; and wherein said functionalizer
(b₁) either bears the ethylenic unsaturation;
(b₂) or does not bear the ethylenic unsaturation, but bears a functional group capable of subsequently reacting with an end-capping agent bearing the ethylenic unsaturation.

11. The unsaturated polyester resin component according to claim 10, wherein said functionalizer
(b₁) bears the ethylenic unsaturation and
is selected from the group consisting of glycidyl(meth)acrylate; or
is selected from the group consisting of allyl isocyanate, adducts of 2-hydroxyethylmethacrylate and an isocyante; or
(b₂) does not bear the ethylenic unsaturation and
is selected from the group consisting of alicyclic polyisocyanates; aromatic polyisocyanates and aliphatic polyisocyanates; wherein said end-capping agent is selected from the group consisting of unsaturated alcohols and hydroxyl substituted acrylic and methacrylic acid esters; or
is selected from the group consisting of alicyclic polyepoxides; aromatic polyepoxides and aliphatic polyepoxides; wherein said end-capping agent is at least one unsaturated carbon acid.

12. The unsaturated polyester resin component according to claim 10 or 11, wherein the functionalizer is isopherone diisocyanate and the end-capping agent is 2-hydroxyethyl-methacrylate.

13. The unsaturated polyester resin component according to any of claims 9 to 12, wherein step (b) comprises reacting the product of step (a) with a functionalizer and
a catalyst; and/or
an inhibitor.

14. The unsaturated polyester resin component according to claim 13, wherein the catalyst is selected from the group consisting of tetramethylammonium chloride, tetramethylammonium bromide and dibutyltindilaurate.

15. A prepromoted unsaturated polyester resin system for the preparation of engineered stone, which system comprises
(i) an unsaturated polyester resin component according to any of claims 1 to 14;
(ii) a metal catalyst capable of catalyzing curing of said unsaturated polyester resin component;
(iii) a quaternary ammonium salt; and
(iv) optionally, one or more additives selected from the group consisting of reactive diluents, accelerators, co-promoters, dispersing agents, UV absorbers, stabilizers, inhibitors and rheology modifiers.

16. The prepromoted unsaturated polyester resin system according to claim 15, wherein the metal catalyst comprises zinc, copper or cobalt.

17. The prepromoted unsaturated polyester resin system according to claim 15 or 16, wherein the quaternary ammonium salt is a benzyl-N,N,N-trialkylammonium salt or a N,N,N,N-tetraalkylammonium salt.

18. The prepromoted unsaturated polyester resin system according to any of claims 15 to 17, which comprises a reactive diluent selected from the group consisting of styrene, substituted styrene, mono-, di- and polyfunctional esters of monofunctional ethylenically unsaturated acids with alcohols or polyfunctional alcohols and/or mono-, di- and polyfunctional esters of unsaturated monofunctional alcohols with carboxylic acids or their derivatives.

19. The prepromoted unsaturated polyester resin system according to any of claims 15 to 18, wherein the content of reactive diluent is in the range of 30±25 wt.-% relative to the total weight of the polyester resin system.

20. A formable composition for the preparation of engineered stone comprising
(A) a prepromoted unsaturated polyester resin system according to any of claims 15 to 19;
(B) an inorganic particulate material; and
(C) a peroxide component.

21. The formable composition according to claim 20, wherein the inorganic particulate material comprises silicon dioxide.

22. The formable composition according to any of claim 20 or 21, wherein the silicon dioxide has an average particle size in the range of 0.045 to 0.6 mm.

23. The formable composition according to any of claims 20 to 22, wherein the peroxide component is benzoyl peroxide (BPO) and/or tert-butyl peroxibenzoate (TBPB).

24. The formable composition according to any of claims 20 to 23, wherein the weight content of the prepromoted unsaturated polyester resin system is about 0.1 wt.-% to about 30 wt.-%, relative to the total weight of the formable composition; and/or wherein the weight content of the inorganic particulate material is about 70 wt.-% to about 99.9 wt.-%, relative to the total weight of the formable composition.

25. The formable composition according to any of claims 20 to 24, wherein the weight content of the prepromoted unsaturated polyester resin system is not more than about 10 wt.-%, relative to the total weight of the formable composition.

26. The formable composition according to any of claims 20 to 25, wherein the weight content of the inorganic particulate material is not more than about 90 wt.-% relative to the total weight of the formable composition.

27. A method for the preparation of an unsaturated polyester resin component according to any of claims 1 to 14 comprising the steps of
(a) reacting a monomer mixture comprising
(i) a fumaric acid component;
(ii) a polyfunctional alcohol component;
(iii) optionally, a polycarboxylic acid component differing from the fumaric acid component;
(iv) optionally, a monocarboxylic acid component; and
(v) optionally, a monofunctional alcohol component;
wherein
the molar content of the (i) fumaric acid component is within the range of from 5.0 to 50 mol.-%; and
the molar content of the (ii) polyfunctional alcohol component is within the range of from 20 to 90 mol.-%;
wherein said molar content in each case is relative to the total molar content of the (i) fumaric acid component, the (ii) polyfunctional alcohol component, the (iii) optionally present polycarboxylic acid component, the (iv) optionally present monocarboxylic acid component, and (v) the optionally present monofunctional alcohol component in the monomer mixture; and
(b) optionally, end-capping the product of step (a).

28. A method for the preparation of an unsaturated polyester resin component according to claim 27, wherein the temperature of step (a) reacting a monomer mixture lies in the range of 100 to 210° C.

29. A method for the preparation of a prepromoted unsaturated polyester resin system according to any of claims 15 to 19 comprising the step of mixing
(i) an unsaturated polyester resin component according to any of claims 1 to 14;
(ii) a metal catalyst capable of catalyzing curing of said unsaturated polyester resin component;
(iii) a quaternary ammonium salt; and
(iv) optionally, one or more additives selected from the group consisting of reactive diluents, accelerators, co-promoters, dispersing agents, UV absorbers, stabilizers, inhibitors and rheology modifiers.

30. A method for the preparation of a formable composition for the preparation of engineered stone according to any of claims 20 to 26 comprising the step of mixing
(A) a prepromoted unsaturated polyester resin system according to any of claims 15 to 19;
(B) an inorganic particulate material; and
(C) a peroxide component.

31. A method for the preparation of engineered stone comprising the steps of
(a) providing a formable composition according to any of claims 20 to 26;
(b) forming the composition prepared in step (a) into a desired shape; and
(c) allowing the composition formed in step (b) to cure.

32. Engineered stone obtainable by the method according to claim 31.

33. Use of a unsaturated polyester resin component according to any of claims 1 to 14 for the preparation of engineered stone.

34. Use of a prepromoted unsaturated polyester resin system according to any of claims 15 to 19 for the preparation of engineered stone.

35. Use of a formable composition according to any of claims 20 to 26 for the preparation of engineered stone.
